(19) United States
(12) Patent Application Publication
(10) Pub. No.: US 2009/0278939 A1
(43) Pub. Date: Nov. 12, 2009

(54) QUALITY MONITORING SYSTEM AND METHOD FOR EXPIRABLE OBJECTS

(75) Inventors: JIUN-NAN LU, Tu-Cheng (TW); PING-HSU LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/189,102

(22) Filed: Aug. 8, 2008

(30) Foreign Application Priority Data
May 8, 2008 (CN) 200810301474.4

(51) Int. Cl. H04N 17/00

(52) U.S. Cl. 348/184; 348/E17.001

(57) ABSTRACT

A quality monitoring system for an expirable object includes an image capturing unit capable of capturing an image of the expirable object, a setting unit capable of setting an expiring date and a warning date and associating the set dates with the captured image, a storage unit configured for storing the captured image and its associated dates, a date acquiring unit capable of acquiring the expiring date and the warning date, a processing unit capable of monitoring whether the warning date is due, and a display unit configured for displaying the captured image and the expiring day of the expirable object.

### BACKGROUND

1. Field of the Invention

The present invention relates to quality controls of expirable objects, and particularly, to a quality monitoring system and method for expirable objects.

2. Description of the Related Art

Expirable objects such as perishable foods and drug are allowed for sale or consumption only before they expire, since after the expiring dates thereof they are not longer safe to be consumed or used. Therefore, people need to check expiring dates of what they are going to take them. This task may be very inconvenient or difficult to perform on a consistent basis.

What is needed, therefore, is to provide a quality monitoring system for expirable objects and quality monitoring method thereof, which can overcome the abovementioned problem.

### SUMMARY

A quality monitoring system for an expirable object includes an image capturing unit capable of capturing an image of the expirable object, a setting unit capable of setting an expiring date and a warning date and associating the set dates with the captured image, a storage unit configured for storing the captured image and its associated dates, a date acquiring unit capable of acquiring the expiring date and the warning date, a processing unit capable of monitoring whether the warning date is due, and a display unit configured for displaying the captured image and the expiring day of the expirable object.

Other advantages and novel features of the present invention will become more apparent from the following detailed description of exemplary embodiments when taken in conjunction with the accompanying drawings.

### BRIEF DESCRIPTION OF THE DRAWINGS

FIG. 1 is a structural block diagram of a quality monitoring system used in an imaging device according to an exemplary embodiment.

FIG. 2 is a flowchart of a quality monitoring method of the quality monitoring system of FIG. 1.

### DETAILED DESCRIPTION OF THE EMBODIMENTS

All of the processes described below may be embodied in, and fully automated via, software code modules executed by one or more general purpose computers or processors. The code modules may be stored in any type of computer-readable medium or other computer storage device. Some or all of the methods may alternatively be embodied in specialized computer hardware.

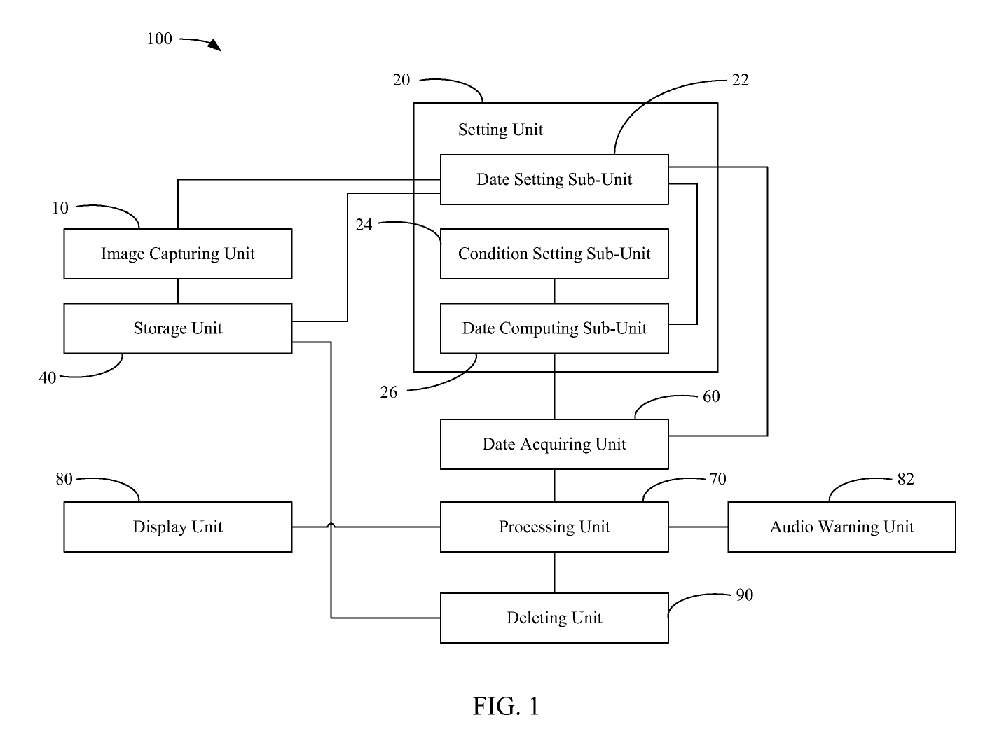

Referring to FIG. 1, a quality monitoring system 100 capable of being integrated in an imaging device (not shown) includes an imaging capturing unit 10, a setting unit 20, a storage unit 40, a date acquiring unit 60, a processing unit 70, a display unit 80 and a deleting unit 90. The imaging device may be a camera, a camcorder or a mobile phone.

The imaging capturing unit 10 is capable of capturing an image of an expirable object. The imaging capturing unit 10 may be a capturing unit built in the imaging device, and may includes a solid state imaging element such as a charge-coupled device (CCD) or a complementary-metal-oxide semiconductor (CMOS) and a micro-controlling unit (MCU) coupled to the solid state imaging element for processing signals from the solid state imaging element to form the image.

The setting unit 10 is capable of setting an expiring date and a warning date and associating the set dates with the captured image. In this embodiment, the setting unit 10 includes a date setting sub-unit 22, a condition setting sub-unit 24, and a date computing sub-unit 26. The date setting sub-unit 22 is capable of setting an expiring date of the expriable object. The date setting sub-unit 22 may set the expiring date in response to a user's input. Alternatively, if the captured image includes a printed expiration date, the date setting sub-unit 22 may set the expiring date by extracting the printed expiration date from the captured image. In this way, the expiring date can be automatically set by the date setting sub-unit 22 when the image is captured. For illustration purpose, annexemplary expiring date is set to Apr. 11, 2008.

The condition setting sub-unit 24 is capable of setting a warning condition. The warning condition may be a default condition, or may be changed by the user. The user may change the warning condition using some function keys on the imaging device when the quality monitoring system is launched. The warning condition may be a condition of how many days before the expiring date when people want to be warned. In this embodiment, the warning condition is three days before the expiring date.

The date computing sub-unit 26 is capable of computing a warning date according to the warning condition and the expiring date. Generally, a system clock, such as a standard calendar (not shown) may be built in the imaging device. The date computing sub-unit 26 computes a warning date according to the system clock, the warning condition and the expiring date. According to the exemplary expiring date and the warning condition in this embodiment, the warning date is computed as Apr. 8, 2008 by the date computing sub-unit 26.

The storage unit 40 is configured for storing the captured image and its associated dates. The storage unit 40 may be a built-in memory of the imaging device or a memory card detachably connected to the imaging device.

The day acquiring unit 60 is capable of acquiring a current date of the imaging device from the system clock, the warning date and the expiring date. In the continuing description, we use Apr. 12, 2008 at current date, the warning date is Apr. 8, 2008 and the expiring date is Apr. 11, 2008.

The processing unit 70 is capable of monitoring whether the warning date is due. If so, the processing unit 70 outputs a display signal, the display unit 80 receives the display signal to display the captured image and the expiring date of the expirable object. For a further warning, the warning system 100 includes an audio warning unit 82 capable of emitting sound. The processing unit 70 also outputs an audio signal, and the audio warning unit 82 emits sound in response to the audio signal.

If the warning date is not due, the processing unit 70 further determines whether the current date is before or after the warning date. If the current date is after the warning date, the processing unit 70 further determines whether the current date is before, same as, or after, the expiring date. If the current date is before or same as the expiring date, the processing unit 70 outputs the display signal. The display unit 80 receives the display signal to display the captured image of the expirable object. If the current date is after the expiring date, the processing unit 70 outputs a deleting signal. The deleting unit 90 receives the deleting signal and deletes the image of the object in the storage unit 40.

In the example, the current date Apr. 12, 2008 is after the warning date Apr. 8, 2008 and the expiring date Apr. 11, 2008. As a result, the deleting unit 90 deletes the captured image of the expirable object in the storage unit 40 according to the deleting signal outputted from the processing unit 70. In this way, a storage amount of the storage unit 40 can be used efficiently.

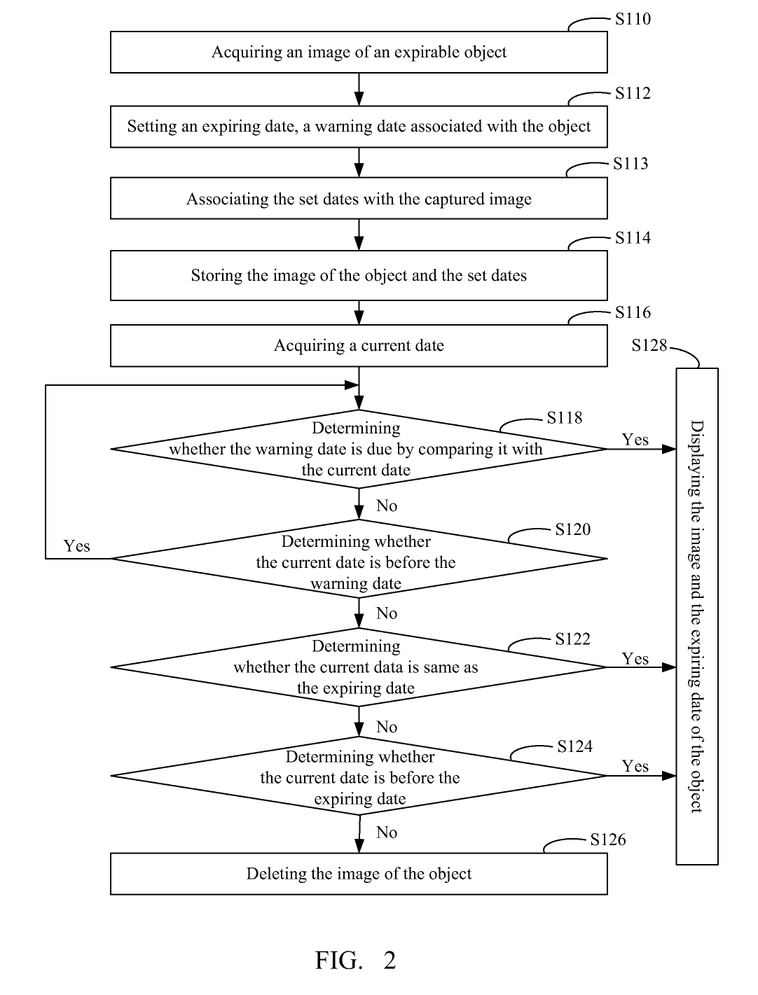

Referring to FIG. 2, a quality monitoring method for the quality monitoring system is shown. The method includes the following steps:
in S110, acquiring an image of an expirable object;
in S112, setting an expiring date, a warning date associated with the object;
in S113, associating the set dates with the captured image;
in S114, storing the captured image of the expirable object and the associated dates;
in S116, acquiring a current date;
in S118, determining whether the warning date is due by comparing it with the current date; if the warning date is due,
in S128, displaying the captured image and the expiring date of the object;
in S120, further determining whether the current date is before the warning date; if the current date is before the warning date, returning to the step S118; if the current date is after the warning date,
in S122, determining whether the current data is same as the expiring date; if the current date is same as the expiring date, returning to the step S128; if the current date is not same as the expiring date,
in S124, determining whether the current date is before the expiring date; if the current date is before the expiring date, returning to the step S128; if the current date is after the expiring date,
in S126, deleting the image of the object.

In the step S110, the image of the object may be captured by the image capturing unit 10, or may be pre-stored in the storage unit 40. In the step S112, the expiring date is set by the date setting sub-unit 22, and the warning date is set according to the expiring date and the warning condition by the date computing sub-unit 26. The warning condition is set by the condition setting sub-unit 24.

In the step S114, the image of the object is stored in the storage unit 40. In the step S116, the date acquiring unit 60 acquires the expiring date from the date setting sub-unit, the warning date from the date computing sub-unit and the current date from the system clock.

In the steps S118 to S128, the processing unit 70 determines whether the warning is due by comparing it with the current date. If so, the processing unit 70 outputs a display signal and an audio signal. The display unit 80 receives the display signal to display the captured image and the expiring date of the object, and the audio warning unit 82 emits sound in response to the audio signal.

If the current date is after the warning date, the processing unit 70 further determines whether the current date is same as the expiring date. If the current date is before or same as the expiring date, the processing unit 70 outputs the display signal. The display unit 80 receives the display signal to display the image of the object. If the current date is after the expiring date, the processing unit 70 outputs a deleting signal. The deleting unit 90 receives deleting signal and deletes the image of the object in the storage unit 40.

In summary, the quality monitoring system and the quality monitoring method can warn people when the expiring date of the object is due. Therefore, some daily necessities going to expire can be disposed properly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A quality monitoring system for an expirable object, comprising:
an image capturing unit capable of capturing an image of the expirable object;
a setting unit capable of setting an expiring date and a warning date, and associating the set dates with the captured image;
a storage unit configured for storing the captured image and its associated dates;
a date acquiring unit capable of acquiring the expiring date and the warning date;
a processing unit capable of monitoring whether the warning date is due; and
a display unit configured for displaying the captured image and the expiring day of the expirable object.

2. The system as claimed in claim 1, further comprising an audio warning unit, the audio warning unit being capable of emitting sound if the warning date is due.

3. The system as claimed in claim 1, wherein the setting unit comprises:
a date setting sub-unit capable of setting the expiring date of the expirable object;
a condition setting sub-unit capable of setting a warning condition; and
a date computing sub-unit capable of computing the warning date according to the warning condition and the expiring date.

4. The system as claimed in claim 3, wherein the date setting unit sets the expiring date in response to a user's input.

5. The system as claimed in claim 3, wherein the captured image comprises a printed expiration date, the date setting unit sets the expiring date by extracting the printed expiration date from the captured image.

6. The system as claimed in claim 1, wherein the processing unit are further capable of monitoring whether the expiring date is due.

7. The system as claimed in claim 6, further comprising a deleting unit, the deleting unit being configured for deleting the captured image if the expiring date is past due.

8. The system as claimed in claim 1, the system capable of being integrated in an imaging device selected from the group consisting of a camera, a camcorder and a mobile phone.

9. A quality monitoring method for an expirable object, comprising:
acquiring an image of the expirable object;
setting an expiring date, a warning date;
associating the set dates with the captured image;
storing the captured image and the associated dates;
acquiring a current date;
determining whether the warning date is due by comparing it with the current date; and
displaying the captured image if the warning date is due.

10. The method as claimed in claim 9, where the setting step comprises:
setting the expiring date;
setting a warning condition; and
computing the warning date according to the expiring date and the warning condition.

11. The method as claimed in claim 10, wherein the expiring date is set in response to a user's input.

12. The method as claimed in claim 10, wherein the captured image comprises a printed expiration date, the expiring date is set by extracting the printed expiration date from the captured image.

13. The method as claimed in claim 9, further comprising emitting sound if the warning date is due.

14. The method as claimed in claim 9, further comprising monitoring whether the expiring date is past due if the current date is past the warning date.

15. The method as claimed in claim 14, further comprising deleting the captured image if the expiring date is past due.
